(19) United States
(12) Patent Application Publication
(10) Pub. No.: US 2009/0248486 A1
(43) Pub. Date: Oct. 1, 2009

(54) SYSTEM FOR SUGGESTING CATEGORIES OF MOBILE KEYWORDS TO REVENUE GENERATORS

(75) Inventors: Arvind Gupta, San Carlos, CA (US); Ashutosh Tiwan, Studio City, CA (US); Gopalakrishnan Venkatraman, Campbell, CA (US); Dominic Cheung, South Pasadena, CA (US); Stacy R. Bennett, Pasadena, CA (US); Douglas B. Koen, Austin, TX (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/059,421

(22) Filed: Mar. 31, 2008

(51) Int. Cl. G06Q 30/00

(52) U.S. Cl. 705/10; 705/14; 705/7

(57) ABSTRACT

A system is described for suggesting categories of mobile keywords to revenue generators. The system may include a processor, a memory and an interface being operatively connected. The memory may store categories associated with mobile carriers, keywords, and advertisements. The interface may communicate with revenue generators and users. The processor may identify the categories and associate each category with related keywords. The processor may receive advertisements and a selected mobile carrier from a revenue generator. The processor may suggest categories associated with the selected mobile carrier to the revenue generator. The processor may receive selected categories from the revenue generator. The processor may associate the keywords associated with the selected categories with the mobile advertisements and selected mobile carrier. The processor may provide one of the mobile advertisements to a user when the user searches for one of the keywords on a mobile device associated with the selected mobile carrier.

### TECHNICAL FIELD

The present description relates generally to a system and method, generally referred to as a system, for suggesting categories of mobile keywords to revenue generators, and more particularly, but not exclusively, to suggesting categories of mobile keywords to revenue generators, where the categories reflect the search intent of users on a mobile device.

### BACKGROUND

The mobile advertising market may grow as users become more comfortable with using their mobile phones as web access devices. The mobile phone may present advertisers with access to consumers everywhere the consumers take their mobile phones. However, users may interact with a mobile device differently than they might interact with a computer. Semantics and user intent may differ on a mobile device and on a computer, resulting in different keywords searched for by users on mobile devices and on computers. Mobile advertisers may be unaware of each mobile keyword which may relate to their mobile advertisement.

### SUMMARY

A system is disclosed for suggesting categories of mobile keywords to revenue generators. The system may include a processor, a memory and an interface. The memory may store categories associated with mobile carriers, keywords and mobile advertisements. The interface may communicate with a revenue generator and a user. The processor may identify the one or more categories associated with one or more mobile carriers. Each of the categories may represent a topic. The processor may associate each category of each mobile carrier with keywords related to the topic. The processor may receive mobile advertisements and a selected mobile carrier from the revenue generator via the interface. The processor may suggest the categories associated with the selected mobile carrier to the revenue generator. The processor may receive selected categories from the revenue generator via the interface. The processor may associate the keywords associated with the selected categories with the mobile advertisements and the selected mobile carrier. The processor may provide one of the mobile advertisements to a user via the interface when the user performs a mobile search for one of the keywords associated with one of the selected categories on a mobile device associated with the selected mobile carrier.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for suggesting categories of mobile keywords to revenue generators.

FIG. 2 is a block diagram of a simplified view of a network environment implementing the system of FIG. 1 or other systems for suggesting categories of mobile keywords to revenue generators.

FIG. 3 is a block diagram of a view of the server side components in the system of FIG. 1 or other systems for suggesting categories of mobile keywords to revenue generators.

FIG. 4 is a flowchart illustrating operations of suggesting categories to revenue generators in the system of FIG. 1, or other systems for suggesting categories of mobile keywords to revenue generators.

FIG. 5 is a flowchart illustrating operations of a revenue generator in the system of FIG. 1, or other systems for suggesting categories of mobile keywords to revenue generators.

FIG. 6 is a flowchart illustrating operations of maintaining categories of keywords in the system of FIG. 1, or other systems for suggesting categories of mobile keywords to revenue generators.

FIG. 7 is an illustration a general computer system that may be used in a system for suggesting categories of mobile keywords to revenue generators.

### DETAILED DESCRIPTION

The present description relates generally to a system and method, generally referred to as a system, for suggesting categories of mobile keywords to revenue generators, and more particularly, but not exclusively, to suggesting categories of mobile keywords to revenue generators, where the categories reflect the search intent of users on a mobile device.

The system may increase the effectiveness of a revenue generator's mobile advertising campaign by allowing the revenue generator to target mobile advertisements to categories of keywords, as opposed to targeting to individual keywords. The categories may represent one or more topics or themes, such as mobile products, sports, etc. The categories may be associated with one or more keywords relevant to the topics. The system may eliminate the need for a revenue generator to identify each of the individual mobile keywords relevant to their mobile advertisement. The system may provide a user with a mobile advertisement of a revenue generator when the user searches for a keyword associated with a category targeted by the revenue generator. The system may maintain separate categories of keywords for each of the mobile carriers represented in the system. Alternatively or in addition the system may maintain one set of mobile categories across all of the mobile carriers represented in the system.

The system may continually update the categories to ensure the categories include the most relevant mobile keywords. The system may automatically re-categorize the keywords on a periodic basis, such as every week. The system may use historical search data and a clustering algorithm to determine the keywords most relevant to a category. The system may remove keywords that become irrelevant to the category or less popular, and may add keywords that become relevant to the category or more popular. Alternatively or in addition one or more administrative users may determine the categories and the keywords associated with each category.

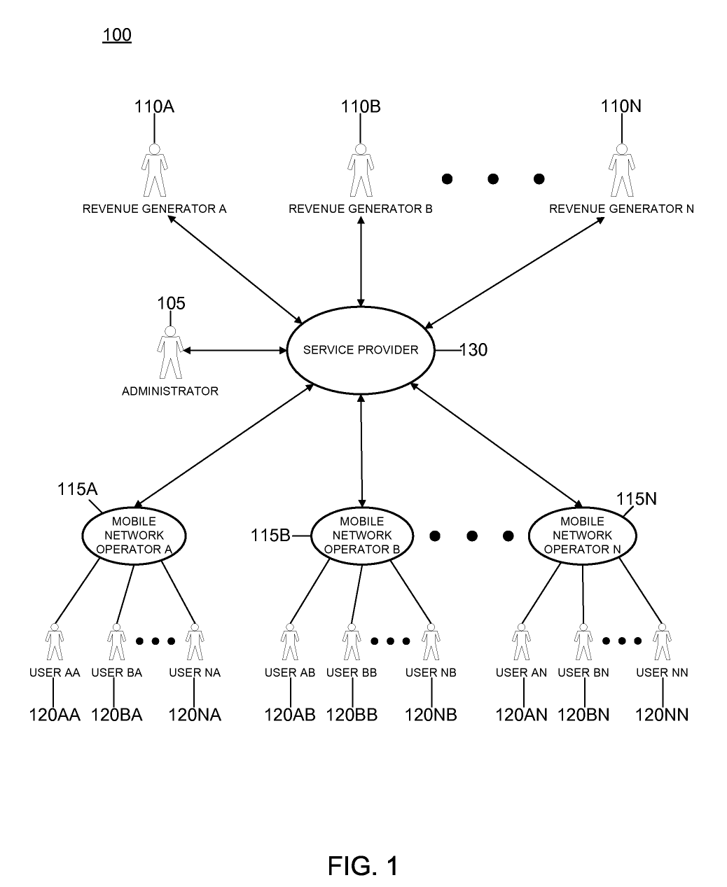

FIG. 1 provides a general overview of a system 100 for suggesting categories of mobile keywords to revenue generators. Not all of the depicted components may be required, however, and some implementations may include additional components. Variations in the arrangement and type of the components may be made without departing from the spirit or scope of the claims as set forth herein. Additional, different or fewer components may be provided.

The system 100 may include an administrator 105, one or more revenue generators 110A-N, such as mobile advertisers, a service provider 130, such as a portal or an advertising service provider, one or more mobile network operators (“MNOs”) 115A-N, more commonly referred to as mobile carriers, or simply carriers, and one or more users 120AA-NN, such as mobile subscribers or consumers. The service provider 130 may implement a mobile advertising campaign management system incorporating an auction based and/or non-auction based advertisement serving system.

The mobile advertising campaign management system may support targeting advertisements to the users 120AA-NN through a variety of mobile advertising tactics, such as search targeting, content match targeting and behavioral profile targeting. Search targeting may refer to targeting advertisements to mobile keywords provided by the users, content match targeting may refer to targeting advertisements to the content of a particular mobile page, and behavioral profile targeting may refer to targeting advertisements to the mobile behavior of the users 120AA-NN.

The revenue generators 110A-N may pay the service provider 130 to serve, or display, advertisements of their goods or services, such as on-line or mobile advertisements, to the users 120AA-NN, such as over mobile messaging, mobile web, the Internet, or generally any mode of displaying advertisements. The advertisements may include sponsored listings, banners ads, popup advertisements, mobile messages, or generally any way of attracting the users 120AA-NN to the web site or mobile site of the revenue generators 110A-N. The revenue generators 110A-N may bid on specific MNOs 115A-N to target their advertisements to. For example, the revenue generator A 110A may bid on one or more keywords searched for via the MNO A 115A. In this case the mobile advertisements of the revenue generator A 110A may only be displayed to the users 120AA-NA when the users 120AA-NA search for the keywords through the MNO A 115A.

The users 120AA-NN may be consumers of goods or services who may be searching for a business, such as the business of one of the revenue generators 110A-N. The users 120AA-NN may be searching for the mobile presence of one of the revenue generators 110A-N, or the real world, or brick and mortar, presence of one of the revenue generators 110A-N. Alternatively or in addition the users 120AA-NN may be machines or other servers, such as a third party server. The users 120AA-NN may need a user identifier or identification (“user ID”) to access the services of the service provider 130. In order to obtain a user ID the users 120AA-NN may need to supply information describing themselves to the service provider 130, such as gender, and/or age of the users 120AA-NN, or generally any information that may be required for the users 120AA-NN to utilize the services provided by the service provider 130. The service provider 130 may collect user behavior data from the users 120AA-NN when they are logged in, such as queries searched for by the users 120AA-NN, links clicked on by the users 120AA-NN and/or any user interactions with the services provided by the service provider 130.

The MNOs 115A-N may provide a mobile network to the users 120AA-NN which may provide a variety of services to the users 120AA-NN, such as the ability to send and receive phone calls, send and receive mobile messages, to access the internet and/or the mobile web, or generally any service that may be implemented on a mobile device. The MNOs 115A-N may store data describing the users 120AA-NN, such as billing addresses, call histories, messaging histories, or generally any data regarding the users 120AA-NN that may be available to the MNOs 115A-N.

The service provider 130 may maintain a mobile portal and/or a web portal, such as a search site, where the service provider 130 may display advertisements of the revenue generators 110A-N to the users 120AA-NN. The users 120AA-NN may use mobile devices to interact with the search site provided by the service provider 130 to search for information on the mobile web. One of the users 120AA-NN, such as the user AA 120AA, may communicate a search query to the service provider 130 relating to the information they are searching for. The service provider 130 may provide data related to the query and mobile advertisements related to the query to the users 120AA-NN. Alternatively or in addition the service provider 130 may provide advertisements to a third party server, such as a third party search portal. The third party server may submit an advertisement request to the service provider 130 through an interface such as an application programming interface (“API”). The service provider 130 may use the data submitted with the request to retrieve and return relevant advertisements to the third party server.

Alternatively or in addition the service provider 130 may be an advertising services provider. Third party entities, such as the MNOs 115A-N may request advertisements from the service provider 130 through an API. The service provider 130 may return mobile advertisements of the revenue generators 110A-N to the MNOs 115A-N. The MNOs 115A-N may then display the advertisements to the users 120AA-NN. The service provider 130 may share revenue with the mobile network operators MNOs 115A-N of the users 120AA-NN for displaying advertisements of the revenue generators 110A-N via their mobile networks. Alternatively or in addition the service provider 130 may share revenue with individual publishers for displaying advertisements of the revenue generators 110A-N on their mobile and/or web sites. The service provider 130 may supply the API to the MNOs 115A-N enabling the MNOs 115A-N to request advertisements from the service provider 130.

The service provider 130 may create one or more categories of keywords related to themes or topics commonly searched for the by the users 120AA-NN, such as “mobile products,” “sports,” etc. For example, the “mobile products” category may include “games,” “ringtones,” or generally any keyword related to a mobile product. The service provider 130 may maintain separate sets of categories for each of the MNOs 115A-N in order to ensure that the categories properly represent the search intent of the users 120AA-NN on each of the MNOs 115A-N. Alternatively or in addition maintaining separate categories for each of the MNOs 115A-N may allow the MNOs 1115A-N to prevent or allow the inclusion of certain keywords in the categories. Alternatively or in addition the service provider 130 may maintain one set of categories across all of the MNOs 115A-N. Alternatively or in addition the service provider 130 may maintain a separate set of categories for each of the users 120AA-NN.

The service provider 130 may associate one or more keywords to each of the categories for each of the MNOs 115A-N. The one or more keywords may relate to the topic represented by the category. The service provider 130 may use an algorithmic inference, such as through matching algorithms, to infer keywords which may relate to a given category. Alternatively or in addition the administrator 105 may interact with the system 100 to create the categories and associate one or more keywords with each of the categories for each of the MNOs 115A-N.

The service provider 130 may dynamically maintain the categories of keywords based on the changing popularity and/or relevance of the keywords. The service provider 130 may analyze the mobile search history of each mobile carrier on a periodic basis, such as every week. The service provider 130 may use the analysis of the mobile search history to determine whether there are any keywords that have become more or less relevant, or popular, for a given category. Keywords that have become less relevant or less popular may be removed from the category and keywords that have become more relevant or popular may be added to the category. When a category changes the system 100 may automatically update the keyword associations of each ad group associated with the category to reflect the changes to the category.

The service provider 130 may allow the revenue generator A 110A to associate the categories with one or more mobile advertisements for each of the MNOs 115A-N, such as the MNO A 115A. When a category is associated with a mobile advertisement, each of the keywords associated with the category may be associated with the mobile advertisement. The service provider 130 may display a mobile advertisement associated with a category to a user AA 120AA when the user AA 120AA performs a search for one of the keywords in the category.

In the system 100, the revenue generators 110A-N may interact with the service provider 130, such as via a web application. The revenue generators 110A-N may send information, such as billing, website or mobile site, keywords, and advertisement information, to the service provider 130 via the web application. The web application may include a web browser or other application such as any application capable of displaying web content. The application may be implemented with a processor such as a personal computer, personal digital assistant, mobile phone, or any other machine capable of implementing a web application. Alternatively or in addition the revenue generators 110A-N may interact with the service provider 130 via a mobile device.

The users 120AA-NN may also interact individually with the service provider 130, through the mobile network operators 115A-N, such as via a mobile phone or any mobile device capable of communicating with the mobile network operators 115A-N. The users 120AA-NN may interact with the service provider 130 via a mobile web based application, a mobile standalone application, or any application capable of running on a mobile device. The service provider 130 may communicate data to the revenue generators 110A-N over a network, and may communicate data to the users 120AA-NN over a network via the MNOs 115A-N. The following examples may refer to a revenue generator A 110A as an online advertiser or mobile advertiser; however the system 100 may apply to any revenue generators 110A-N who may desire to serve advertisements to users 120AA-NN over mobile devices.

A revenue generator A 110A who is a mobile advertiser may maintain one or more accounts with the service provider 130. For each account the revenue generator A 110A may maintain one or more campaigns. For each campaign the revenue generator A 110A may maintain one or more ad groups. An ad group may be associated with one or more MNOs 115A-N, and may include one or more keywords, or categories, and one or more mobile advertisements. When a revenue generator A 110A creates an ad group for a MNO A 1115A, the system 100 may provide the revenue generator A 110A with one or more categories. The revenue generator A 110A may select one or more categories to be associated with the ad group. The service provider 130 may associate all of the keywords in the category with the ad group for the MNO A 115A. Alternatively or in addition the service provider 130 may provide the keywords associated with the categories to the revenue generator A 110A and may allow the revenue generator A 110A to select one or more of the keywords to associate with the ad group.

Furthermore, the service provider 130 may generate reports based on the data collected from the users 120AA-NN and communicate the reports to the revenue generators 110A-N to assist the revenue generators 110A-N in measuring the effectiveness of their mobile advertising campaigns. The reports may indicate the number of times the users 120AA-NN viewed a mobile advertisement of the revenue generators 110A-N, the number of times a mobile advertisement of the revenue generators 110A-N was clicked on by the users 120AA-NN, or generally any information useful to the revenue generators 110A-N. The reports may aggregate the data collected from the users 120AA-NN based on the categories associated with the mobile advertisements.

More detail regarding the aspects of a mobile advertising auction-based systems, as well as the structure, function and operation of the service provider 130 as a mobile advertising provider, as mentioned above, can be found in commonly owned U.S. patent application Ser. No. 11/712,276, filed on Feb. 28, 2007, entitled, “SYSTEM FOR SERVING ADVERTISEMENTS OVER MOBILE DEVICES,” which is hereby incorporated herein by reference in its entirety. The systems and methods herein associated with mobile advertising campaign management may be practiced in combination with methods and systems described in the above-identified patent application incorporated by reference.

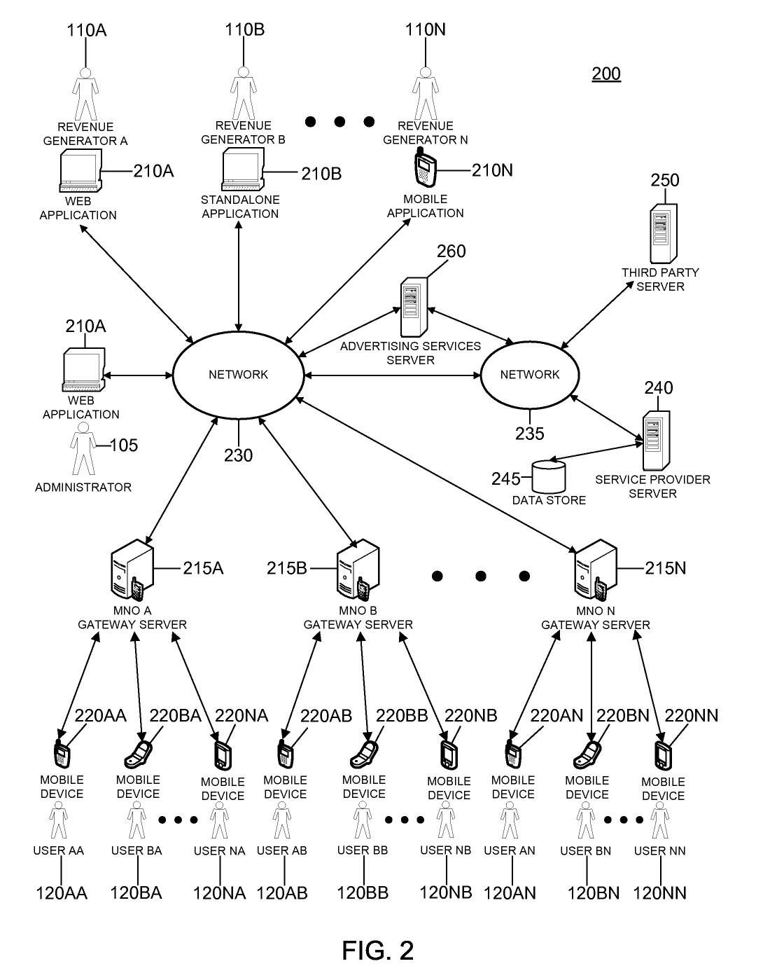

FIG. 2 provides a simplified view of a network environment implementing a system 200 for suggesting categories of mobile keywords to revenue generators. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 200 may include one or more web applications, standalone applications and mobile applications 210A-N, which may be collectively or individually referred to as client applications of the revenue generators 110A-N. The system 200 may also include one or more mobile applications, or mobile apps, which may be running on one or more mobile devices 220AA-NN of the users 120AA-NN. The system 200 may also include an administrator 105, one or more MNO gateway servers 215A-N, a network 230, a network 235, a data store 245, the service provider server 240, a third party server 250, and an advertising services server 260.

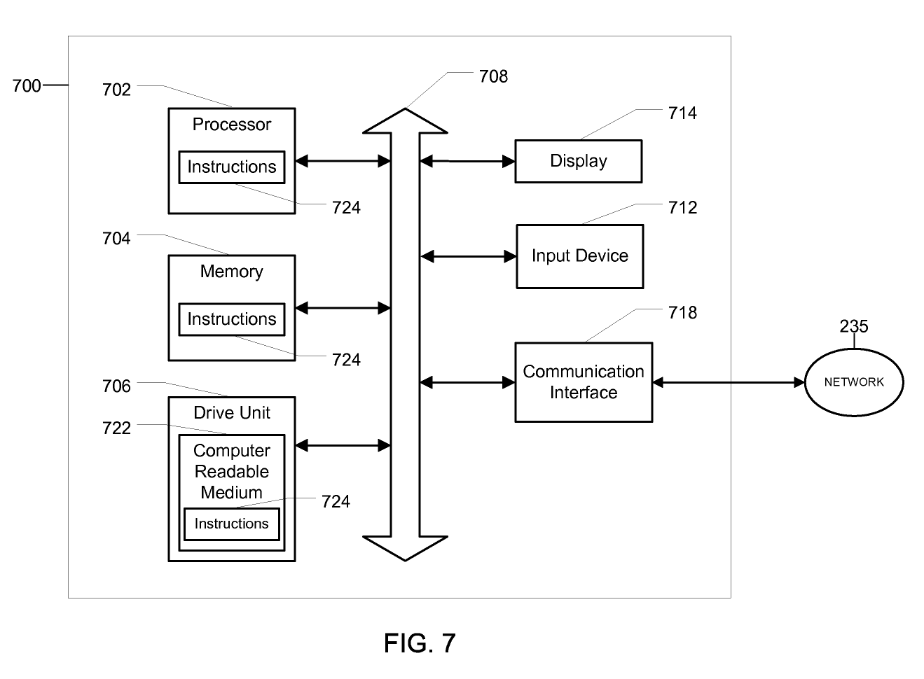

Some or all of the advertisement services server 260, service provider server 240, and third-party server 250 may be in communication with each other by way of network 235 and may be implemented with the system or components described below in FIG. 7. The advertisement services server 260, third-party server 250 and service provider server 240 may each represent multiple linked computing devices. Multiple distinct third party servers, such as the third-party server 250, may be included in the system 200. The third-party server 250 may be an MNO gateway server 215A-N or a server associated with, or in communication with an MNO gateway server 215A-N.

The data store 245 may be operative to store data, such as data describing the categories and the associations between the categories and the keywords. The data store 245 may store data relating to interactions with the users 120AA-NN. The system 100 may maintain and update the data describing the associations between the categories and the keywords. There may be a server or a set of servers dedicated to tracking and updating the associations. The data store 245 may include one or more relational databases or other data stores that may be managed using various known database management techniques, such as, for example, SQL and object-based techniques. Alternatively or in addition the data store 245 may be implemented using one or more of the magnetic, optical, solid state or tape drives. The data store 245 may be in communication with the service provider server 240. Alternatively or in addition the data store 245 may be in communication with the service provider server 240 through the network 235.

The networks 230, 235 may include wide area networks (WAN), such as the internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The revenue generators 110A-N may use a web application 210A, standalone application 210B, or a mobile application 210N, or any combination thereof, to communicate to the service provider server 240, such as via the networks 230, 235. The service provider server 240 may communicate to the revenue generators 110A-N via the networks 230, 235, through the web applications, standalone applications or mobile applications 210A-N. The administrator 105 may use a web application 210A to interact with the service provider server 240 over the networks 230, 235.

The users 120AA-NN may use a mobile application running on a mobile device 220AA-220NN, such as a mobile web browser, to communicate with the service provider server 240, via the MNO gateway servers 215A-N and the networks 230, 235. The service provider server 240 may communicate to the users 120AA-NN via the networks 230, 235 and the MNO gateway servers 215A-N, through the mobile devices 220AA-NN.

The web applications, standalone applications, mobile applications and mobile devices 210A-N, 220AA-NN may be connected to the network 230 in any configuration that supports data transfer. This may include a data connection to the network 230 that may be wired or wireless. Any of the web applications, standalone applications and mobile applications 210A-N, may individually be referred to as a client application. The web application 210A may run on any platform that supports web content, such as a web browser or a computer, a mobile phone, personal digital assistant (PDA), pager, network-enabled television, digital video recorder, such as TIVO, automobile and/or any appliance capable of data communications.

The standalone application 210B may run on a machine that may have a processor, memory, a display, a user interface and a communication interface. The processor may be operatively connected to the memory, display and the interfaces and may perform tasks at the request of the standalone application 210B or the underlying operating system. The memory may be capable of storing data. The display may be operatively connected to the memory and the processor and may be capable of displaying information to the revenue generator B 110B. The user interface may be operatively connected to the memory, the processor, and the display and may be capable of interacting with the revenue generator B 110B. The communication interface may be operatively connected to the memory, and the processor, and may be capable of communicating through the networks 230, 235 with the service provider server 240, third party server 250 and advertising services server 260. The standalone applications 210B may be programmed in any programming language that supports communication protocols. These languages may include: SUN JAVA, C++, C#, ASP, SUN JAVASCRIPT, asynchronous SUN JAVASCRIPT, or ADOBE FLASH ACTIONSCRIPT, amongst others.

The mobile application 210N may run on any mobile device which may have a data connection. The mobile applications 210N may be a web application 210A, a standalone application 210B, or a mobile browser. The mobile devices 220AA-NN may be one of a broad range of electronic devices which may include mobile phones, PDAs, and laptops and notebook computers. The mobile devices 220AA-NN may have a reduced feature set, such as a smaller keyboard and/or screen, and may be incapable of supporting a traditional web search and/or display.

The data connection of the mobile devices 220AA-NN may be a cellular connection, such as a GSM/GPRS/WCDMA connection, a wireless data connection, an internet connection, an infra-red connection, a Bluetooth connection, or any other connection capable of transmitting data. The data connection may be used to connect directly to the network 230, or to connect to the network 230 through the MNO gateway servers 215A-N.

The MNO gateway servers 215A-N may control the access the mobile devices 220AA-NN may have to the networks 230, 235. The MNO gateway servers 215A-N may also control the technology supporting the respective mobile devices 220AA-NN. This may affect aspects of the user experience, such as signal strength and availability, speed and billing mechanisms. For example, the MNO A gateway server 215A may only allow the users 120AA-NA access to content provided by partners of the MNO A 115A. Furthermore, the MNO gateway servers 215A-N may only allow users 120AA-NN access to data in a specific format, such as WML, XHTML, NTT DOCOMO IMODE HTML, or cHTML. Alternatively or in addition, the mobile devices 220AA-NN may only support one of the aforementioned formats.

The service provider server 240 may include one or more of the following: an application server, a data source, such as a database server, a middleware server, and an advertising services server. One middleware server may be a mobile commerce platform, such as the YAHOO! SUSHI platform, which may properly encode data, such as mobile pages or mobile advertisements, to the formats specific to the MNO gateway servers 215A-N. The service provider server 240 may co-exist on one machine or may be running in a distributed configuration on one or more machines. The service provider server 240 may receive requests from the users 120AA-NN and the revenue generators 110A-N and may serve web pages and/or mobile pages to the users 120AA-NN and web pages and/or mobile pages to the revenue generators 110A-N based on their requests.

The third party server 250 may include one or more of the following: an application server, a data source, such as a database server, a middleware server, and an advertising services server. The third party server 250 may co-exist on one machine or may be running in a distributed configuration on one or more machines. Alternatively or in addition, the third party server 250 may be a third party matching algorithm provider server. The advertising services server 260 may provide a platform for the inclusion of advertisements in pages, such as web pages or mobile pages. The advertisement services server 260 may be used for providing mobile advertisements that may be displayed to the users 120AA-NN. The third party server 250 may request advertisements from the service provider server 240 or the advertisement services server 260 via an API.

The service provider server 240, the third party server 250 and the advertising services server 260 may be one or more computing devices of various kinds, such as the computing device in FIG. 7. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 210A may employ HTTP to request information, such as a web page, from a web server, which may be a process executing on the service provider server 240 or the third-party server 250.

There may be several configurations of database servers, application servers, middleware servers and advertising services servers included in the service provider server 240 or the third party server 250. Database servers may include MICROSOFT SQL SERVER, ORACLE, IBM DB2 or any other database software, relational or otherwise. The application server may be APACHE TOMCAT, MICROSOFT IIS, ADOBE COLDFUSION, YAPACHE or any other application server that supports communication protocols. The middleware server may be any middleware that connects software components or applications. The application server on the service provider server 240 or the third party server 250 may serve pages, such as web pages to the users 120AA-NN and the revenue generators 110A-N. The advertising services server 260 may provide a platform for the inclusion of advertisements in pages, such as web pages. The advertising services server 260 may also exist independent of the service provider server 240 and the third party server 250.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

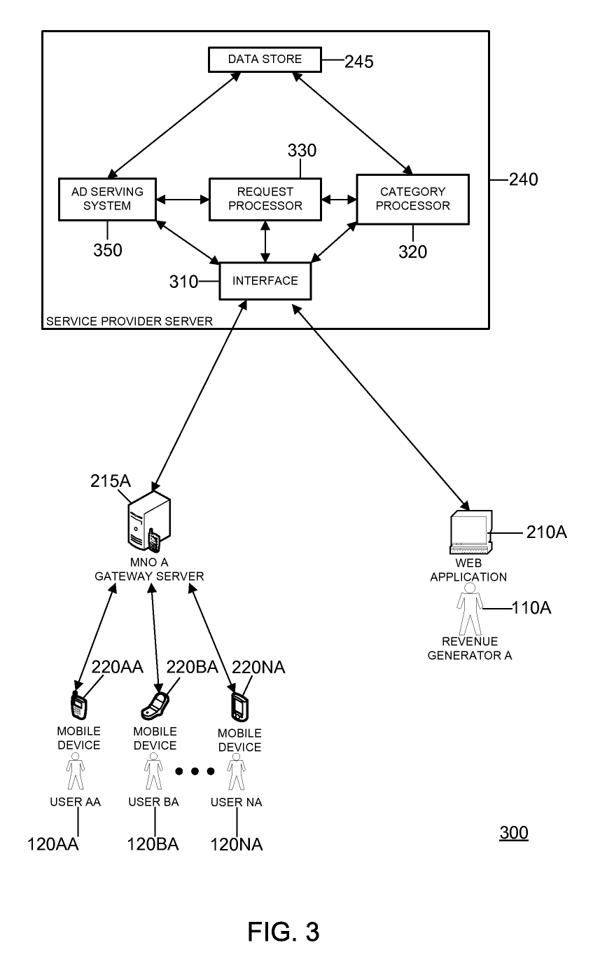

FIG. 3 illustrates a block diagram of an implementation of the system of FIG. 1 or other systems for suggesting categories of mobile keywords to revenue generators. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 300 may include the service provider server 240, the MNO A gateway server 215A, the mobile devices 220AA-NA, the users 120AA-NA, the web application 210A and the revenue generator A 110A. The service provider server 240 may include an interface 310, a request processor 330, a category processor 320, an ad serving system 350 and a data store 245. The interface 310 may enable the service provider server 240 to communicate with the MNO A gateway server 215A and the web application 210A. The request processor 330 may process requests from the mobile devices 220AA-NA and/or the MNO A gateway server 215A and/or the web application 210A. The request processor 330 may provide requests from the web application 210A to the category processor 320 and may provide any other requests to the ad serving system 350. The ad serving system 350 may provide one or more mobile advertisements to the mobile devices 220AA-NA based on the request received.

The category processor 320 may receive a request from a revenue generator A 110A to associate one or more categories with an ad group. The category processor 320 may create the association and may store the association in the data store 245. The category processor 320 may create one or more categories and may associate one or more keywords with the categories for each of the MNOs 115A-N. The category processor 320 may store the categories, the keywords and the associations between the categories and the keywords in the data store 245. The category processor 320 may analyze the search history of the users 120AA-NN on a periodic basis to determine whether keywords should be added or removed from the categories. Keywords that become more popular and/or relevant to a category may be added to the category while keywords that become less popular and/or relevant may be removed from a category. Alternatively or in addition the category processor 320 may provide an interface to the administrator 105. The interface may allow the administrator 105 to interact with the data store 245 and maintain the categories and the keywords associated with each category.

In operation one of the revenue generators 110A-N, such as the revenue generator A 110A, may interact with the system 100. The revenue generator A 110A may create a new ad group for one or more of the MNOs 115A-N, such as the MNO A 115A. The revenue generator A 110A may request the categories of keywords associated with the MNO A 115A. The interface 310 may receive the request and may communicate the request to the request processor 330. The request processor 330 may identify the request as a category request and may pass the request to the category processor 320. The category processor 320 may retrieve the categories associated with the MNO A 115A and may provide the categories to the revenue generator A 110A via the interface 310. The revenue generator A 110A may select one or more categories to associate with the ad group. The category processor 320 may store the associations between the one or more categories and the ad group in the data store 245. The revenue generator A 110A may also identify one or more mobile advertisements to associate with the ad group.

In operation one of the users 120AA-NA, such as the user AA 120AA, may search for a keyword via the mobile device 220AA. The keyword may be associated with one of the categories selected by the revenue generator A 110A. The mobile device 220AA may communicate the query to the service provider server 240 via the MNO A gateway server 215A. The interface 310 may receive the request and communicate the request to the request processor 330. The request processor 330 may process the request to determine the requesting MNO A 115A, and may communicate the request to the ad serving system 350. The ad serving system 350 may retrieve one or more mobile advertisements of the revenue generator A 110A targeted to the MNO A 115A and the category of the keyword. The ad serving system 350 may provide the one or more mobile advertisements to the user AA 120AA through the interface 310 and the MNO A gateway server 215A.

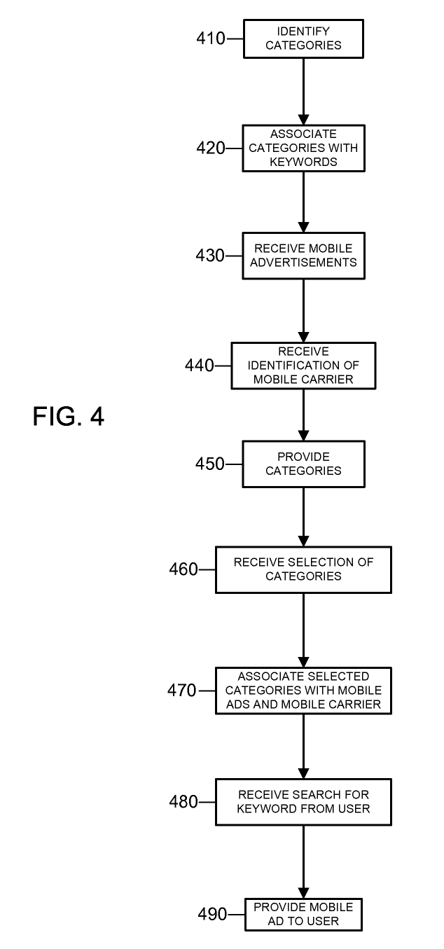

FIG. 4 is a flowchart illustrating operations of suggesting categories to revenue generators in the system of FIG. 1, or other systems for suggesting categories of mobile keywords to revenue generators. At block 410 the service provider 130 may identify one or more categories. The categories may represent topics, or themes, commonly searched for by the users 120AA-NN. The service provider 130 may analyze the search history of the users 120AA-NN to identify the one or more categories. The service provider 130 may identify separate categories for each of the MNOs 115A-N. Alternatively or in addition the administrator 105 may identify the one or more categories.

At block 420 the service provider 130 may associate the categories with one or more keywords for each of the MNOs 115A-N. The keywords may relate to the topic represented by the category. The service provider 130 may identify the keywords in the search history of the users 120AA-NN for each of the MNOs 115A-N. At block 430 the service provider 130 may receive one or more mobile advertisements from one of the revenue generators 110A-N, such as the revenue generator A 110A. The mobile advertisements may be associated with an ad group created by the revenue generator A 110A. At block 440 the service provider 130 may receive the identification of the MNO A 115A associated with the mobile advertisements from the revenue generator A 110A.

At block 450 the service provider 130 may provide the revenue generator A 110A with one or more categories associated with the MNO A 115A. The service provider 130 may retrieve the categories from the data store 245. At block 460 the service provider 130 may receive a selection of categories from the revenue generator A 110A to be associated with the mobile advertisements and the MNO A 115A. At block 470 the service provider 130 may associate the categories selected by the revenue generator A 110A with the mobile advertisements and the MNO A 115A. Alternatively or in addition the service provider 130 may associate each of the keywords in each selected category with the mobile advertisements and the MNO A 115A.

Alternatively or in addition, the revenue generator A 110A may create an ad group and may associate the ad group with one or more mobile advertisements, one or more mobile carriers and one or more categories and/or individual keywords. The mobile advertisements, mobile carriers and categories may be associated with the ad group in any order.

At block 480 the service provider 130 may receive a search keyword from a user AA 120AA via the MNO A 115A. The keyword may be associated with one of the categories selected by the revenue generator A 110A for the MNO A 115A. At block 490 the service provider 130 may retrieve one or more mobile advertisements associated with the keyword and the MNO A 115A and may provide the one or more mobile advertisements to the user AA 120AA.

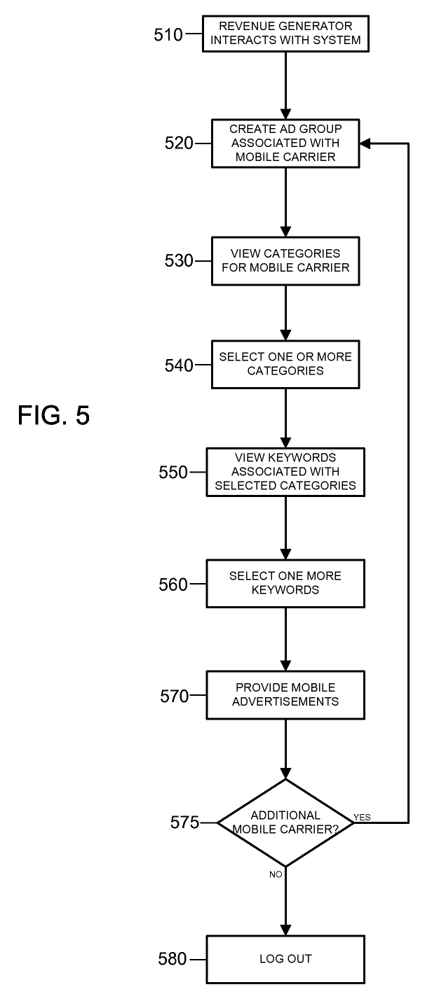

FIG. 5 is a flowchart illustrating operations of a revenue generator in the system of FIG. 1, or other systems for suggesting categories of mobile keywords to revenue generators. At block 510 one of the revenue generators 110A-N, such as the revenue generator A 110A, may interact with the system 100, such as by logging into the system 100. At block 520 the revenue generator A 110A may create an ad group associated with one or more of the mobile carriers 115A-N, such as the MNO A 115A. At block 530 the revenue generator A 110A may view the categories of keywords associated with the MNO A 115A. At block 540 the revenue generator A 110A may select one or more categories. At block 550 the revenue generator A 110A may view the keywords associated with the selected categories. At block 560 the revenue generator A 110A may select one or more of the keywords to associate with the ad group. Alternatively or in addition all the keywords associated with the categories selected at block 540 may be associated with the ad group.

At block 570 the revenue generator A 110A may provide one or more mobile advertisements to be associated with the keywords and the MNO A 115A. At block 575 the revenue generator A 110A may determine whether to create ad groups associated with the additional MNOs 115B-N. If the revenue generator A 110A wishes to create ad groups associated with the additional MNOs 115B-N, the system 100 may move to block 520. If the revenue does not wish to create ad groups associated with the additional MNOs 115B-N, the system 100 may move to block 580. At block 580 the revenue generator A 110A may log out of the system 100.

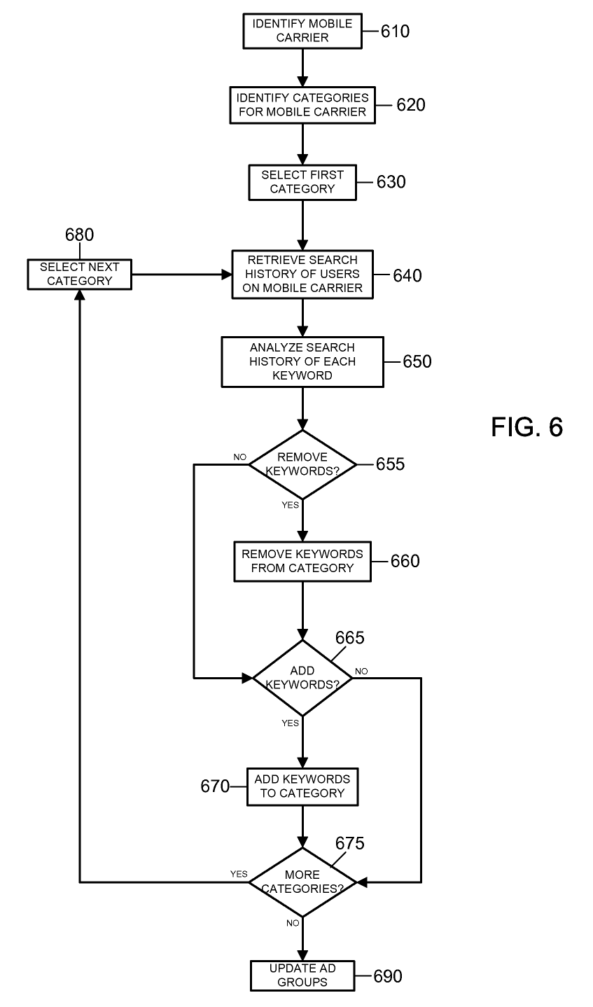

FIG. 6 is a flowchart illustrating operations of maintaining categories of keywords in the system of FIG. 1, or other systems for suggesting categories of mobile keywords to revenue generators. At block 610 the system 100 may identify one of the MNOs 115A-N to maintain the categories of, such as the MNO A 115A. At block 620 the service provider 130 may identify the categories associated with the MNO A 115A. At block 630 the service provider 130 may select the first category to maintain. At block 640 the service provider 130 may retrieve the search history of the users 120AA-NA on the MNO A 115A related to the selected category. The search history may be retrieved from the data store 245. The search history related to the category may include searches for any of the keywords in the selected category. Alternatively or in addition the search history may include related keywords that are not part of the category but were searched for in conjunction with a keyword in the category.

At block 650 the service provider 130 may analyze the search history of each keyword related to the selected category. For example, the service provider 130 may count the number of times each keyword was searched for by one of the users 120AA-NA over a period of time, such as the last week. Alternatively or in addition the service provider 130 may also count the number of times the related keywords that are not part of the category were searched for over the period of time. At block 655 the service provider 130 may determine whether to remove any of the keywords from the category. The service provider 130 may remove keywords from the category if the number of times the keyword was searched for over the period of time is less than a threshold. If the service provider 130 determines one or more keywords should be removed from the category, the system 100 may move to block 660. At block 660 the service provider 130 may remove the one or more keywords from the category.

If at block 655 the service provider 130 determines that no keywords should be removed from the category, the system 100 may move to block 665. At block 665 the system 100 may determine whether any of the related keywords should be added to the category. The service provider 130 may add a keyword to the category if the number of times the keyword was searched for over a period of time was greater than a threshold. If the service provider 130 determines that one or more keywords should be added to the category, the system 100 may move to block 670. At block 670 the service provider 130 may add the keywords to the category for the MNO A 115A.

If at block 665 the service provider 130 determines that no keywords should be added to the category, the system 100 may move to block 675. At block 675 the service provider 130 may determine whether there are additional categories to maintain for the MNO A 115A. If there are additional categories to maintain for the MNO A 115A the system 100 may move to block 680. At block 680 the service provider 130 may select the next category. The system 100 may then move to block 640 and repeat the process for the next category. Once the service provider 130 has maintained all of the categories for the MNO A 115A the system 100 may move to block 690. At block 690 the service provider 130 may update the ad groups associated with the updated categories. For example, if a keyword was removed from a category then the service provider 130 may disassociate the keyword from any ad group associated with the category. Likewise, if a keyword was added to a category the service provider 130 may associate the keyword with any ad group associated with the category.

Alternatively or in addition the categories may be associated directly with the ad groups. In this case the changes to keywords associated with the categories would not need to be propagated across each of the individual ad groups. Alternatively or in addition the administrator 105 may manually perform the operations of maintaining the categories associated with each of the MNOs 115A-N. The system 100 may repeat the operations of FIG. 6 for each of the MNOs 115A-N.

FIG. 7 illustrates a general computer system 700, which may represent a service provider server 240, a third party server 250, an advertising services server 260, one of the mobile devices 220AA-NN or any of the other computing devices referenced herein. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The computer system 700 may include a set of instructions 724 that may be executed to cause the computer system 700 to perform any one or more of the methods or computer based functions disclosed herein. The computer system 700 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 724 (sequential or otherwise) that specify actions to be taken by that machine. In a particular embodiment, the computer system 700 may be implemented using electronic devices that provide voice, video or data communication. Further, while a single computer system 700 may be illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, such as, a central processing unit (CPU), a graphics processing unit (GPU), or both. The processor 702 may be a component in a variety of systems. For example, the processor 702 may be part of a standard personal computer or a workstation. The processor 702 may be one or more general processors, digital signal processors, application specific integrated circuits, field programmable gate arrays, servers, networks, digital circuits, analog circuits, combinations thereof, or other now known or later developed devices for analyzing and processing data. The processor 702 may implement a software program, such as code generated manually (i.e., programmed).

The computer system 700 may include a memory 704 that can communicate via a bus 708. The memory 704 may be a main memory, a static memory, or a dynamic memory. The memory 704 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 704 may include a cache or random access memory for the processor 702. Alternatively or in addition, the memory 704 may be separate from the processor 702, such as a cache memory of a processor, the system memory, or other memory. The memory 704 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 704 may be operable to store instructions 724 executable by the processor 702. The functions, acts or tasks illustrated in the figures or described herein may be performed by the programmed processor 702 executing the instructions 724 stored in the memory 704. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 700 may further include a display 714, such as a liquid crystal display (LCD), an organic light emitting diode (OLED), a flat panel display, a solid state display, a cathode ray tube (CRT), a projector, a printer or other now known or later developed display device for outputting determined information. The display 714 may act as an interface for the user to see the functioning of the processor 702, or specifically as an interface with the software stored in the memory 704 or in the drive unit 706.

Additionally, the computer system 700 may include an input device 712 configured to allow a user to interact with any of the components of system 700. The input device 712 may be a number pad, a keyboard, or a cursor control device, such as a mouse, or a joystick, touch screen display, remote control or any other device operative to interact with the system 700.

The computer system 700 may also include a disk or optical drive unit 706. The disk drive unit 706 may include a computer-readable medium 722 in which one or more sets of instructions 724, e.g. software, can be embedded. Further, the instructions 724 may perform one or more of the methods or logic as described herein. The instructions 724 may reside completely, or at least partially, within the memory 704 and/or within the processor 702 during execution by the computer system 700. The memory 704 and the processor 702 also may include computer-readable media as discussed above.

The present disclosure contemplates a computer-readable medium 722 that includes instructions 724 or receives and executes instructions 724 responsive to a propagated signal; so that a device connected to a network 235 may communicate voice, video, audio, images or any other data over the network 235. The instructions 724 may be implemented with hardware, software and/or firmware, or any combination thereof. Further, the instructions 724 may be transmitted or received over the network 235 via a communication interface 718. The communication interface 718 may be a part of the processor 702 or may be a separate component. The communication interface 718 may be created in software or may be a physical connection in hardware. The communication interface 718 may be configured to connect with a network 235, external media, the display 714, or any other components in system 700, or combinations thereof. The connection with the network 235 may be a physical connection, such as a wired Ethernet connection or may be established wirelessly as discussed below. Likewise, the additional connections with other components of the system 700 may be physical connections or may be established wirelessly. In the case of a service provider server 240, a third party server 250, an advertising services server 260, the servers may communicate with users 120AA-NN and the revenue generators 110A-N through the communication interface 718.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 722 may be a single medium, or the computer-readable medium 722 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 722 may include a solid-state memory such as a memory card or other package that houses one or more non-volatile read-only memories. The computer-readable medium 722 also may be a random access memory or other volatile re-writable memory. Additionally, the computer-readable medium 722 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method for suggesting categories of mobile keywords to revenue generators, the method comprising:
identifying one or more categories associated with one or more mobile carriers, wherein each category represents a topic;
associating each category with one or more mobile keywords related to the topic;
receiving one or more mobile advertisements and an identification of a selected mobile carrier from a revenue generator;
suggesting the one or more categories associated with the selected mobile carrier to the revenue generator;
receiving one or more selected categories from the revenue generator;
associating the one or more keywords associated with the one or more selected categories with the one or more mobile advertisements and the selected mobile carrier; and
providing at least one of the one or more mobile advertisements to a user when the user performs a mobile search for at least one of the one or more keywords associated with the one or more selected categories on a mobile device associated with the selected mobile carrier.

2. The method of claim 1 further comprising approving of the one or more keywords associated with each category by the mobile carrier associated with each category.

3. The method of claim 1 further comprising modifying the one or more keywords associated with each category based on a plurality of keywords searched for by a plurality of users on the associated mobile carrier.

4. The method of claim 1 further comprising formatting the one or more mobile advertisements for display on at least one of the one or more mobile carriers.

5. The method of claim 1 wherein providing at least one of the mobile advertisements to the user further comprises causing the at least one mobile advertisement to be displayed on the mobile device of the user.

6. A method for suggesting categories of mobile keywords to revenue generators, the method comprising, the method comprising:
receiving an identification of a mobile carrier from a revenue generator;
suggesting one or more categories to the revenue generator wherein each category is associated with one or more keywords and the mobile carrier;
suggesting each of the keywords associated with the one or more categories to the revenue generator;
receiving one or more selected keywords associated with the one or more categories from the revenue generator;
receiving one or more mobile advertisements from the revenue generator;
associating the one or more selected keywords, the one or more mobile advertisements and the mobile carrier; and
providing at least one of the one or more mobile advertisements to a user when the user performs a mobile search for at least one of the one or more selected keywords on a mobile device associated with the mobile carrier.

7. The method of claim 6 further comprising approving of the one or more keywords associated with each category by the mobile carrier associated with category.

8. The method of claim 6 further comprising modifying the one or more keywords associated with each category based on a plurality of keywords searched for by a plurality of users on the associated mobile carrier.

9. The method of claim 6 further comprising formatting the one or more mobile advertisements for display on the mobile carrier.

10. The method of claim 6 wherein providing at least one of the mobile advertisements to the user further comprises causing at least one of the mobile advertisements to be displayed on the mobile device of the user.

11. A system for suggesting categories of mobile keywords to revenue generators, the system comprising:
means for receiving an identification of a mobile carrier from a revenue generator;
means for suggesting one or more categories to the revenue generator wherein each category is associated with one or more keywords and the mobile carrier;
means for suggesting each of the keywords associated with the one or more categories to the revenue generator;
means for receiving one or more selected keywords associated with the one or more categories from the revenue generator;
means for receiving one or more mobile advertisements from the revenue generator;
means for associating the one or more selected keywords, the one or more mobile advertisements and the mobile carrier; and
means for providing at least one of the one or more mobile advertisements to a user when the user performs a mobile search for at least one of the one or more selected keywords on a mobile device associated with the mobile carrier.

12. The system of claim 11 further comprising means for approving of the one or more keywords associated with each category by the mobile carrier associated with category.

13. The system of claim 11 further comprising means for modifying the one or more keywords associated with each category based on a plurality of keywords searched for by a plurality of users on the associated mobile carrier.

14. The system of claim 11 further comprising means for formatting the one or more mobile advertisements for display on the mobile carrier.

15. The system of claim 11 wherein means for providing at least one of the mobile advertisements to the user further comprises means for causing at least one of the mobile advertisements to be displayed on the mobile device of the user.

16. A system for suggesting categories of mobile keywords to revenue generators, comprising:
a memory to store one or more categories associated with one or more mobile carriers, one or more keywords, and one or more mobile advertisements;
an interface operatively connected to the memory to communicate with a revenue generator and a user; and
a processor operatively connected to the memory and the interface the processor for running instructions, wherein the processor identifies the one or more categories associated with the one or more mobile carriers, wherein each category represents a topic, associates each category with one or more keywords related to the topic, receives one or more mobile advertisements and an identification of a selected mobile carrier from the revenue generator via the interface, suggests the one or more categories associated with the selected mobile carrier to the revenue generator, receives one or more selected categories from the revenue generator via the interface, associates the one or more keywords associated with the one or more selected categories with the one or more mobile advertisements and the selected mobile carrier, and provides at least one of the one or more mobile advertisements to the user via the interface when the user performs a mobile search for at least one of the one or more keywords associated with the one or more selected categories on a mobile device associated with the selected mobile carrier.

17. The system of claim 16 wherein the processor allows the mobile carrier associated with each category to approve of the one or more keywords associated with each category.

18. The system of claim 16 wherein the processor modifies the one or more keywords associated with each category based on a plurality of keywords searched for by a plurality of users on the associated mobile carrier.

19. The system of claim 16 wherein the processor formats the one or more mobile advertisements for display on at least one of the one or more mobile carriers.

20. The system of claim 16 wherein the processor causes the at least one mobile advertisement to be displayed on the mobile device of the user.
